(19) United States
(12) Patent Application Publication
(10) Pub. No.: US 2019/0223564 A1
(43) Pub. Date: Jul. 25, 2019

(54) GEMSTONE CUT

(71) Applicant: Shailesh Dayalbhai GOTI, Surat (IN)

(72) Inventor: Shailesh Dayalbhai GOTI, Surat (IN)

(21) Appl. No.: 16/318,140

(22) PCT Filed: Oct. 17, 2016
(86) PCT No.: PCT/IN2016/000251

§ 371 Date: Jan. 16, 2019

(30) Foreign Application Priority Data
Jul. 19, 2016 (IN) 201621024626

(51) Int. Cl. A44C 17/00

(52) U.S. Cl. CPC A44C 17/001; B28D 5/00

(57) ABSTRACT

Disclosed is a gemstone (1), comprising: a crown region (20) having flat octagonal surface (30) at top; a pavilion region (40) having conical shape; a culet region (50) being provided at the tip of conical pavilion region; and a girdle region (10) being positioned between the crown region (20) and pavilion region (40), the girdle region (10) consists of upper girdle portion (11) connected to the crown region and lower girdle portion (12) connected to the pavilion region. The crown region (20) comprises: single table facet (30) having octagonal shape forming the top of crown region; sixteen kite facets (32) being positioned between the table facet and upper girdle portion, eight triangular shaped star facets (31) extending from the table facet to kite facets, sixteen upper girdle facets (33) being situated closest to the upper girdle portion. The the pavilion region (40) comprises: eight tiles facets (41) extending from the culet region (50), sixteen blade facets (43) being situated closets to the lower girdle portion (12), eight hexagonal shaped hexy facets (42) extending from tiles facets (41) to blade facets (43), eight spear facets (44) extending from hexy facets (42) to lower girdle portion (12). A gemstone cut is in such a way that it creates hearts and arrow loupe appearance in the gemstone which resembles to Lotus flower (Padma in Sanskit).

### FIELD OF THE INVENTION

The present invention relates to jewelry. More particularly it relates to a gemstone cut.

### BACKGROUND OF THE INVENTION AND PRIOR ART

Cut refers not to a diamond's shape (e.g. round, oval, pear, etc.) but to a diamond's proportions, symmetry and polish. The beauty of a diamond depends more on cut than any other factor. Though extremely difficult to analyze and quantify, diamond cut has three primary effects on appearance: brilliance (the brightness created by the combination of all the white light reflections from the surface and the inside of a polished diamond), fire (the dispersion of light into the colors of the visible spectrum, seen as flashes of color), and scintillation (the flashes of light and dark, or sparkle, when a diamond or light source is moved).

Diamond proportion refers to the relationship between the size, shape, and angle of each facet of a diamond. A wide range of combinations are possible, ultimately determining the diamond's interaction with light.

Various patent literature is available in respect of diamond cut which is discussed herein below to provide background of the invention.

U.S. Pat. No. 6,430,963 B1 discloses a brilliant gemstone cut, having a crown, a girdle and a pavilion. The crown and the pavilion are both brilliant cut. The crown has a flat table shaped as an equilateral n-sided polygon, n corner facets and n upper girdle facets. The girdleis also shaped as an n-sided polygon. The pavilion has n rib lines, which converge at a culet, n lower girdle facets, n bezel star facets and double n number of corner facets. The rib lines subdivide the pavilion into n equivalent parts.

Patent Publication No. WO 2002017742 A1 discloses a brilliant gemstone cut, having a crown (12), a girdle (50) and a pavilion (30). The crown (12) and the pavilion (30) are both brilliant cut. The crown (12) has a flat table (16) shaped as an equilateral n-sided polygon, n corner facets (20) and n upper girdle facets (24). The girdle (50) is also shaped as an n-sided polygon. The pavilion has n rib lines (36), which converge at a culet (38), n lower girdlefacets (32), n bezel star facets (42) and double n number of corner facets (34). The rib lines (36) subdivide the pavilion (30) into n equivalent parts.

US Patent publication. 20050252241 A1 discloses a brilliant gemstone cut, having a crown, a girdle and a pavilion. The crown and the pavilion are both brilliant cut. The crown has a flat table shaped with multiple faceted bezel facets. The pavilion has n rib lines, which converge at a culet, and are multiple faceted, and lower girdle facets which are multiple facets.

U.S. Pat. No. 6,604,382 B2 disclose a new diamond cutting method and a diamond shape or proportion giving an increased brightness and different brilliant colors to the cut jewel. A piece of diamond having a crown or bezel and a pavilion converging up and down from its girdle is prepared; the table of the crown is cut into a regular polygon having straight sides of an integer multiple of three; star facets, upper-main facets and paired upper-girdle facets are formed on the oblique annular surface between the polygonal table and the girdle; and lower-girdle facets and lower-main facets are cut on the pavilion. The height of the diamond piece is approximately 64% of the diameter of the girdle; the height of the crown is approximately 15.7%; the height of the pavilion is approximately 48.3%;

and the largest width of the girdle is approximately 1.2 to 1.4%. The angle formed between the ridge of the crown and the ridge of the pavilion is approximately 77 degrees.

Patent Publication No. WO 2003086133 A2 discloses a novel gemstone cut comprising a crown, a girdle, and a pavilion, wherein the gemstone includes precious gemstones (such as diamonds) and semi-precious gemstones. The crown includes an octagonal table, which is surrounded by eight triangular star facets. Eight table bezels are disposed in-between the star facets and eight mid-bezels are disposed in-between the table bezels. Furthermore, the gemstone's pavilion has eight concentrically arranged culet pavilion facets, girdle pavilion facet and a bottom small break facet that are disposed in-between the culet pavilion facets. The gemstone's girdle has eight left top half facets and eight right top half facets, located in-between the girdle bezels of the crown, and eight left bottom half facets and eight right bottom half facets disposed in-between the girdle pavilion facets and bottom small break facets.

However, in the field of gemstone, the customer always wants different variety as well as maximum brilliance. Hence, there is a constant need to work in these areas.

### OBJECT OF THE INVENTION

Main object of the invention is to provide a gemstone cut which has maximum fire and brilliance.

Another object of the invention is to provide the gemstone cut which reflects optimum light that enters the diamond, creating exceptional sparkle and life.

Yet another object of the invention is to provide the gemstone cut which has each facet properly placed and angled so as to maximize the amount of light that reflects back out of the crown (top) of the diamond, to the eye of the observer.

### STATEMENT OF THE INVENTION

In order to achieve the foregoing objectives, the present invention provides a gemstone, comprising:
a crown region having flat octagonal surface at top;
a pavilion region having conical shape;
a culet region being provided at the tip of conical pavilion region; and
a girdle region being positioned between the crown region and pavilion region, the girdle region consists of upper girdle portion connected to the crown region and lower girdle portion connected to the pavilion region;
wherein the crown region comprises:
   single table facet having octagonal shape forming the top of crown region;
   sixteen kite facets being positioned between the table facet and upper girdle portion,
   eight triangular shaped star facets extending from the table facet to kite facets,
   sixteen upper girdle facets being situated closest to the upper girdle portion,
wherein the pavilion region comprises:
   eight tiles facets extending from the culet region,
   sixteen blade facets being situated closets to the lower girdle portion,
   eight hexagonal shaped hexy facets extending from tiles facets to blade facets,
   eight spear facets extending from hexy facets to lower girdle portion,
wherein gemstone cut is in such a way that it creates hearts and arrow loupe appearance in the gemstone.

Preferably, size of the table facet is 55% to 59% of girdle diameter, height of the crown region is 8% to 14.5% of the girdle diameter, height of the girdle region is 2.5% to 4.5% of the girdle diameter, height of the pavilion region is 41.4% to 43.5% of the girdle diameter and height of the gemstone from the table facet to culet region is 56% to 60.5% of the girdle diameter.

Typically, the gemstone is diamond.

### BRIEF DESCRIPTION OF THE DRAWING

FIG. 1: Shows perspective view of the gemstone in accordance to present invention.

FIG. 2(A): Shows highlighted crown region of the gemstone of FIG. 1.

FIG. 2(B): Shows highlighted girdle region of the gemstone of FIG. 1.

FIG. 2(C): Shows highlighted pavilion region of the gemstone of FIG. 1.

FIG. 3: Shows perspective view of gemstone of FIG. 1 with dimensions of different parts of the gemstone.

FIG. 4: Shows section view of the crown region of the gemstone of FIG. 1.

FIG. 5: Shows section view of the pavilion region of the gemstone of FIG. 1.

FIG. 6: Shows section view of the gemstone of FIG. 1. with hearts and arrow loupe appearance which resembles to Lotus flower (Padma in Sanskit).

### DETAILED DESCRIPTION OF THE INVENTION

The invention and its further features and advantages are explained in more detail on the basis of the exemplary embodiments schematically represented in the figures.

While this invention is illustrated and described in a preferred embodiment, the gemstone may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

It should be noted that the gemstone of the present invention can be a precious stone or a semi-precious stone, but in the preferred embodiment, the gemstone is a diamond. Thus, the type of gemstone should not be used to restrict the scope of the present invention. Furthermore, the specific parameters (e.g., depths, heights, ratios, and angles) are used for illustrative purposes only and should not be used to limit the scope of the present invention. Additionally, the shape of the gemstone in the figures corresponding to the specification and the preferred embodiment are for illustrative purposes only, and one skilled in the art can envision using other shapes (e.g., an oval shape, a marquis shape, etc.).

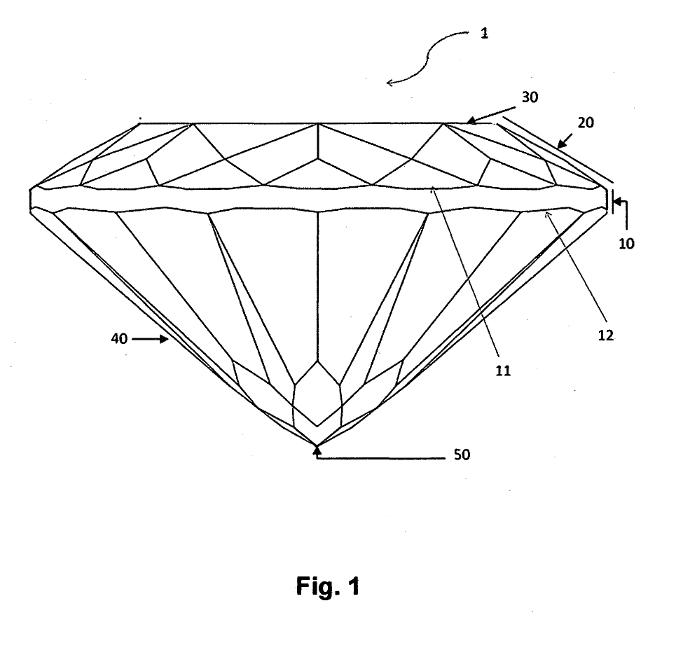

Referring to FIG. 1, the gemstone (1) in accordance to present invention is illustrated. The gemstone (1) mainly includes a girdle region (10), crown region (20), pavilion region (40) and culet region (50).

Referring to FIG. 1, the girdle region (10) is positioned between the crown region (20) and pavilion region (40). The girdle region (10) consists of upper girdle portion (11) connected to the crown region and lower girdle portion (12) connected to the pavilion region.

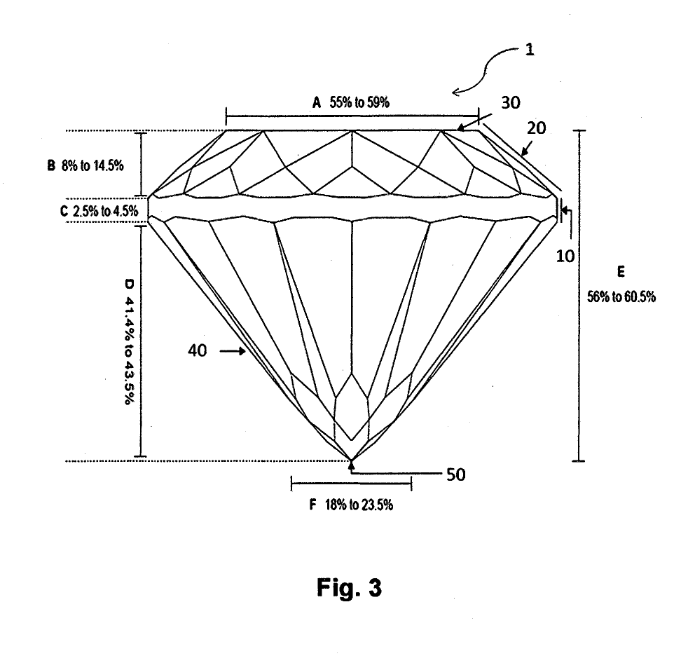

Referring to FIG. 4, the crown region (20) comprises total 41 facets. A single table facet (30) having octagonal shape forms the top of crown region. Sixteen kite facets (32) are positioned between the table facet and upper girdle portion. The eight triangular shaped star facets (31) extends from the table facet to kite facets. Each of the star facet (31) sits on one of the sides of the table facet. Sixteen upper girdle facets (33) are situated curcumfertially and closest to the upper girdle portion.

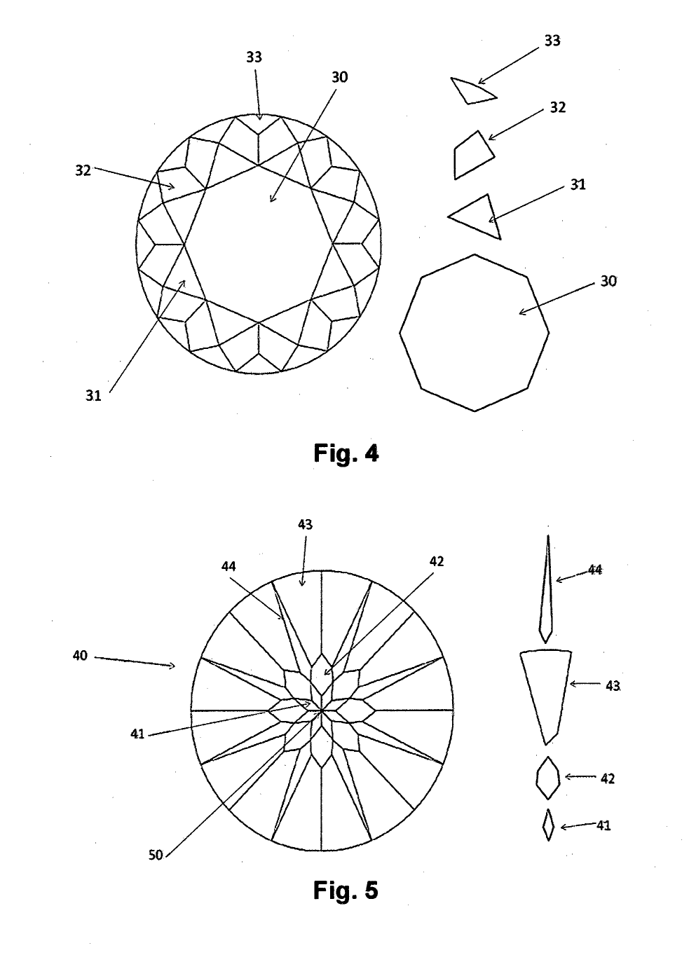

Referring to FIG. 5, pavilion region (40) having conical shape. The culet region (50) is provided at the tip of conical pavilion region. The pavilion region (40) comprises 40 facets. Eight tiles facets (41) extend from the culet region (50) and surround the culet region (50). Sixteen blade facets (43) are situated closets to the lower girdle portion (12). Eight hexagonal shaped hexy facets (42) extends from tiles facets (41) to blade facets (43). Eight spear facets (44) extends from hexy facets (42) to lower girdle portion (12).

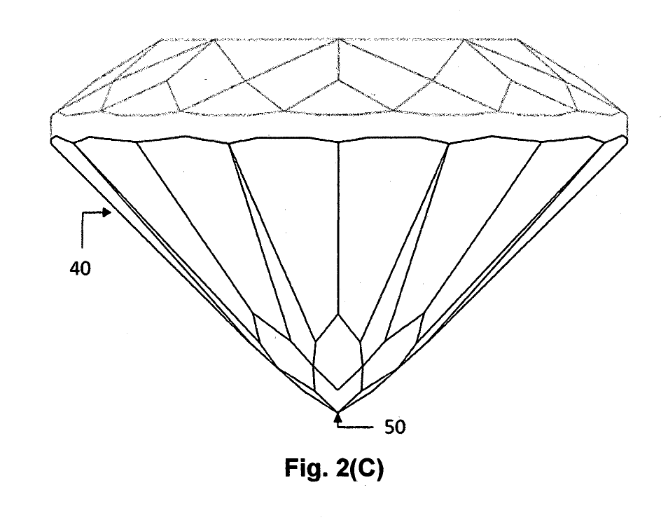

Referring to FIG. 3, various dimensions and sizes of the parts of gemstone (1) are illustrated. The size of the table facet is 55% to 59% of girdle diameter. The height of the crown region is 8% to 14.5% of the girdle diameter. The height of the girdle region is 2.5% to 4.5% of the girdle diameter. The height of the pavilion region is 41.4% to 43.5% of the girdle diameter. The height of the gemstone from the table facet to culet region is 56% to 60.5% of the girdle diameter.

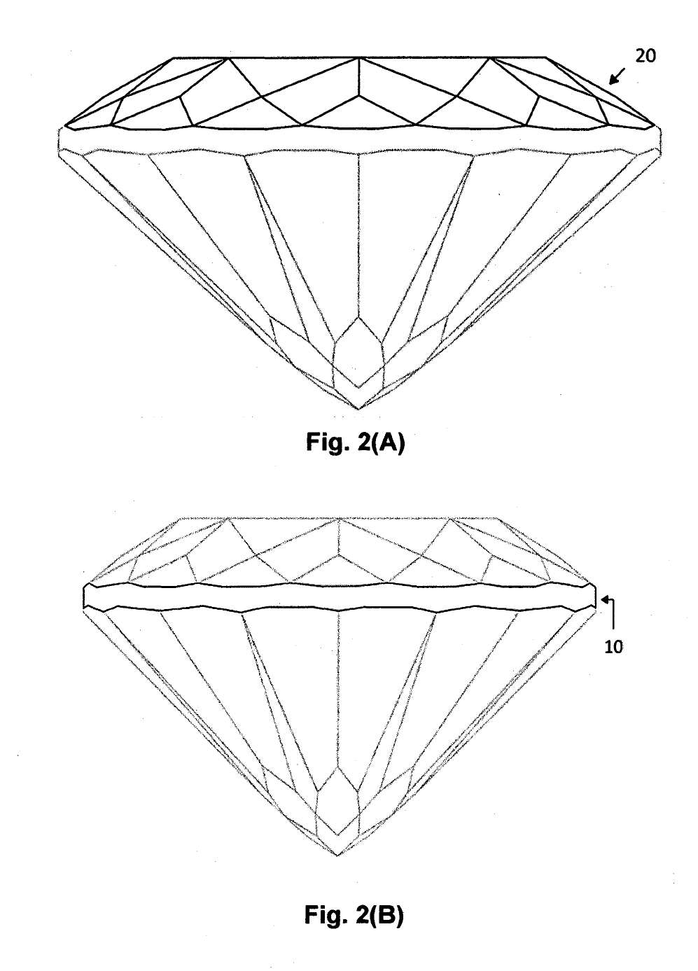

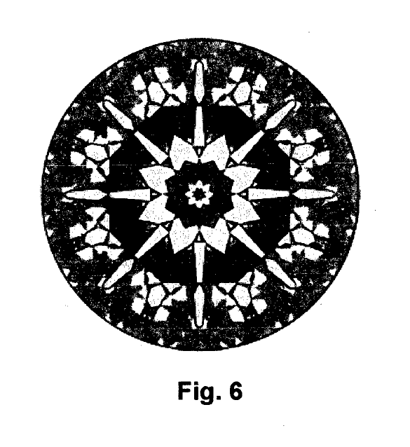

Referring to FIG. 6, the gemstone cut creating hearts and arrow loupe appearance in the gemstone is illustrated. The pattern of Hearts & Arrow loupe is formed by the arrangements and the size of the facets on crown region, pavilion region and girdle region as described above in FIGS. 1 to 5 above The pattern looks like a flower and resembles to Lotus flower (Padma in Sanskit). Therefore, one can name this pattern/cut as Padma diamond pattern/cut.

While various embodiments of the present invention have been described above, it should be understood that they have been presented by way of example only, and not limitation. It will be understood by those skilled in the relevant art that various changes in form and details may be made therein without departing from the spirit and scope of the invention.

I claim:

1. A gemstone (1), comprising:
a crown region (20) having flat octagonal surface (30) at top;
a pavilion region (40) having conical shape;
a culet region (50) being provided at the tip of conical pavilion region; and
a girdle region (10) being positioned between the crown region (20) and pavilion region (40), the girdle region (10) consists of upper girdle portion (11) connected to the crown region and lower girdle portion (12) connected to the pavilion region;
wherein the crown region (20) comprises:
single table facet (30) having octagonal shape forming the top of crown region;
sixteen kite facets (32) being positioned between the table facet and upper girdle portion,
eight triangular shaped star facets (31) extending from the table facet to kite facets,
sixteen upper girdle facets (33) being situated closest to the upper girdle portion,
wherein the pavilion region (40) comprises:
eight tiles facets (41) extending from the culet region (50),
sixteen blade facets (43) being situated closets to the lower girdle portion (12),
eight hexagonal shaped hexy facets (42) extending from tiles facets (41) to blade facets (43),
eight spear facets (44) extending from hexy facets (42) to lower girdle portion (12),
wherein gemstone cut is in such a way that it creates hearts and arrow loupe appearance in the gemstone.

2. The gemstone cut as claimed in claim 1 wherein size of the table facet is 55% to 59% of girdle diameter, height of the crown region is 8% to 14.5% of the girdle diameter, height of the girdle region is 2.5% to 4.5% of the girdle diameter, height of the pavilion region is 41.4% to 43.5% of the girdle diameter and height of the gemstone from the table facet to culet region is 56% to 60.5% of the girdle diameter.

3. The gemstone cut as claimed in claim 1 wherein the gemstone (1) is diamond.

4. The gemstone cut as claimed in claim 3 wherein the diamond cut is in such a way that it creates hearts and arrow loupe appearance which resembles to Lotus flower (Padma in Sanskit).
